(19) United States
(12) Patent Application Publication
(10) Pub. No.: US 2024/0081570 A1
(43) Pub. Date: Mar. 14, 2024

(54) Watch Stand Device

(71) Applicant: Joshua Weir, Dallas, TX (US)

(72) Inventor: Joshua Weir, Dallas, TX (US)

(21) Appl. No.: 18/185,690

(22) Filed: Mar. 17, 2023

Related U.S. Application Data
(60) Provisional application No. 63/404,681, filed on Sep. 8, 2022.

(51) Int. Cl. A47G 29/08; F21V 23/04

(52) U.S. Cl. CPC A47G 29/08; F21V 23/0464

(57) ABSTRACT

The present invention relates to a watch stand device. The device is primarily comprised of a base, at least one dowel, at least one first stand member, and at least one second stand member. The base has at least one opening that receives the dowel such that the dowel is vertically secured within the base. The first member and second member can then be attached to the dowel via openings in each member. The dowel is secured and supported by a moment arm created by the base. Each member is then supported in a position parallel to the base via moment arms created with the dowel.

### CROSS-REFERENCE TO RELATED APPLICATION

The present application claims priority to, and the benefit of, U.S. Provisional Application No. 63/404,681, which was filed on Sep. 8, 2022, and is incorporated herein by reference in its entirety.

### FIELD OF THE INVENTION

The present invention relates generally to the field of watch stands. More specifically, the present invention relates to a watch stand device primarily comprised of a base, at least one dowel, at least one first stand member, and at least one second stand member. The base has at least one opening that receives the dowel such that the dowel is vertically secured within the base. The first member and second member can then be attached to the dowel via openings in each member. The dowel is secured and supported by a moment arm created by the base. Each member is then supported in a position parallel to the base via moment arms created with the dowel. Accordingly, the present disclosure makes specific reference thereto. Nonetheless, it is to be appreciated that aspects of the present invention are also equally applicable to other like applications, devices, and methods of manufacture.

### BACKGROUND

Many individuals own wristwatches and consider them an investment in their style. Many watches have been or will be passed down to family members, which imparts a significant amount of sentimental value to a watch. Whenever a watch is not worn, there is a risk of damage if it is not stored in an organized manner. Individuals may toss a watch on a table or place it in an unorganized drawer, leading to cosmetic or functional damage to a priceless memento.

Watch organizers are known in the art, but may damage the rear of a watch casing, as said organizers typically contact the casing during use. Further, watches may be of differing sizes, yet most watch organizers are non-adjustable. Further, said watch organizers are typically bulky and cannot be easily transported.

Therefore, there exists a long-felt need in the art for an improved watch stand. There also exists a long-felt need in the art for a watch stand device that cannot damage the rear of a watch casing during use. Further, there exists a long-felt need in the art for a watch stand device that can be universally used with all sizes of watches. In addition, there exists a long-felt need in the art for a watch stand device that can be easily transported.

The subject matter disclosed and claimed herein, in one embodiment thereof, comprises a watch stand device. The device is primarily comprised of a base, at least one dowel, at least one first stand member, and at least one second stand member. The base has at least one opening that receives the dowel such that the dowel is vertically secured within the base. The first member and second member can then be attached to the dowel via openings in each member. The members support the band of a watch without contacting the rear of the watch casing. The dowel is secured and supported by a moment arm created by the base. Each member is then supported in a position parallel to the base via moment arms created with the dowel. As a result, no fasteners are used to secure any components of the device during use.

In this manner, the watch stand device of the present invention accomplishes all the foregoing objectives and provides an improved watch stand. In doing so, the device provides a watch stand that cannot damage the rear of a watch casing during use and that can be universally used with all sizes of watches. In addition, the device can be easily transported.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a watch stand device. The device is primarily comprised of a base, at least one dowel, at least one first stand member, and at least one second stand member. The base is also comprised of at least one opening. The opening is preferably angled.

The opening further receives the first end of at least one dowel. The first end is preferably angled such that the first end forms an acute angle relative to the bottom surface. As a result, the angle of the dowel within the angled opening of the base allows the dowel to rest vertically within the base. The location of the opening in the base is such that the moment force created by the dowel is less than the overturning force of the base.

The device is also comprised of a first stand member and a second stand member. The first stand member is convex in shape such that it matches the contour of a human wrist. The member is comprised of at least one opening that allows the member to be slid onto the dowel from the second end of the dowel.

The second stand member is concave in shape such that it matches the contour of a human wrist. The member is comprised of at least one opening that allows the member to be slid onto the dowel from the second end of the dowel.

Together, the shape of both members form a generally circular shape to mimic a human wrist. This allows a watch to be easily stored. It should be noted that each member does not contact the rear of the watch. In this manner, each member cannot scratch or damage the rear of the watch casing.

Both members are positioned perpendicular to the dowel during use and are maintained at said perpendicular position via the moment arm created relative to the dowel. The opening of each member may be positioned on any area of the member to create the necessary moment arm.

Because the members attach to the dowel with no fasteners (in an arrangement wherein the members are parallel to the base), the members can be repositioned along the dowel to hold watches of different sizes. As such, the device is universal. In one embodiment, the members may be magnetic and can magnetically attach to a metal dowel. In addition, the use of no fasteners allows the device to be easily disassembled for transport.

Accordingly, the watch stand device of the present invention is particularly advantageous as it provides an improved watch stand that cannot damage the rear of a watch casing during use and that can be universally used with all sizes of watches. In addition, the device can be easily transported. In this manner, the watch stand device overcomes the limitations of existing watch stands known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a watch stand device of the present invention in accordance with the disclosed architecture;

FIG. 2 illustrates a side view of one potential embodiment of a watch stand device of the present invention in accordance with the disclosed architecture;

FIG. 3 illustrates a side view of one potential embodiment of a watch stand device of the present invention while holding a watch in accordance with the disclosed architecture; and

FIG. 4 illustrates a front view of one potential embodiment of a watch stand device of the present invention while holding a watch in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved watch stand. There also exists a long-felt need in the art for a watch stand device that cannot damage the rear of a watch casing during use. Further, there exists a long-felt need in the art for a watch stand device that can be universally used with all sizes of watches. In addition, there exists a long-felt need in the art for a watch stand device that can be easily transported.

The present invention, in one exemplary embodiment, is comprised of a watch stand device primarily comprised of a base, at least one dowel, at least one first stand member, and at least one second stand member. The base is also comprised of at least one opening. The opening is preferably angled and receives the first end of at least one dowel. The first end is preferably angled such that the first end forms an acute angle relative to the bottom surface. As a result, the angle of the dowel within the angled opening of the base allows the dowel to rest vertically within the base. The location of the opening in the base is such that the moment force created by the dowel is less than the overturning force of the base.

The device is also comprised of a first stand member and a second stand member. The first stand member is convex in shape such that it matches the contour of a human wrist. The member is comprised of at least one opening that allows the member to be slid onto the dowel from the second end of the dowel. The second stand member is concave in shape such that it matches the contour of a human wrist. The member is comprised of at least one opening that allows the member to be slid onto the dowel from the second end of the dowel.

Together, the shape of both members form a generally circular shape to mimic a human wrist. This allows a watch to be easily stored. It should be noted that each member does not contact the rear of the watch. In this manner, each member cannot scratch or damage the rear of the watch casing. Both members are positioned perpendicular to the dowel during use and are maintained at said perpendicular position via the moment arm created relative to the dowel. The opening of each member may be positioned on any area of the member to create the necessary moment arm.

Because the members attach to the dowel with no fasteners (in an arrangement wherein the members are parallel to the base), the members can be repositioned along the dowel to hold watches of different sizes. As such, the device is universal and can be used with watches of any size. In one embodiment, the members may be magnetic and can magnetically attach to a metal dowel. In addition, the use of no fasteners allows the device to be easily disassembled for transport.

Accordingly, the watch stand device of the present invention is particularly advantageous as it provides an improved watch stand that cannot damage the rear of a watch casing during use and that can be universally used with all sizes of watches. In addition, the device can be easily transported. In this manner, the watch stand device overcomes the limitations of existing watch stands known in the art.

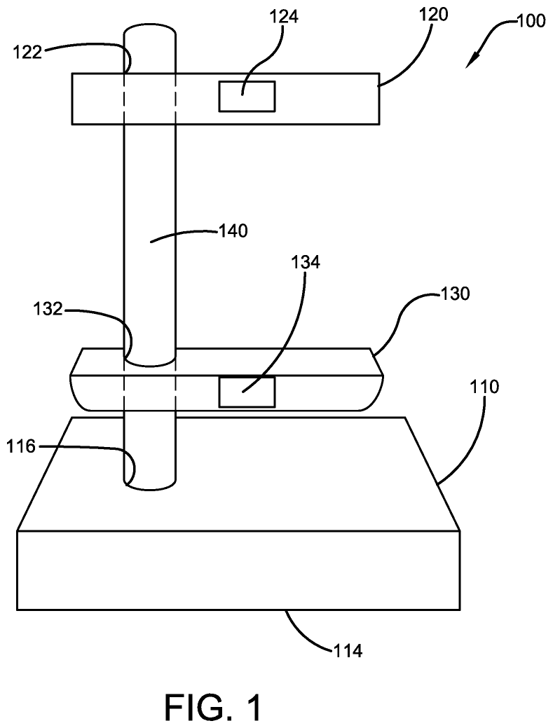

Referring initially to the drawings, FIG. 1 illustrates a front view of one potential embodiment of a watch stand device 100 of the present invention in accordance with the disclosed architecture. The device 100 is primarily comprised of a base 110, at least one dowel 140, at least one first stand member 120, and at least one second stand member 130. Unless otherwise specified herein, the device 100 and all components may be made from any material. Said material includes any rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The material may also include any wood known in the art such as, but not limited to, oak, maple, mahogany, cherry, pine, cedar, etc. The material may also include any metal such as, but not limited to, stainless steel, aluminum, etc.

The base 110 is preferably square or rectangular in shape. However, the base 110 may be any shape such as, but not limited to, circular, oval, triangular, polygonal, etc. In one embodiment, the base 110 may be made from a heavy metal material to prevent the device 100 from falling over during use.

In one embodiment, the bottom surface 114 of the base 110 may be textured with a recessed or raised texture or may be non-textured. The bottom surface 114 is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc. In this manner, the device 100 is further prevented from moving or falling over during use 100.

The base 110 is also comprised of at least one opening 116. The opening 116 may extend fully through the base. In a different embodiment, the opening 116 extends only partially into the base 110. The opening 116 is preferably angled.

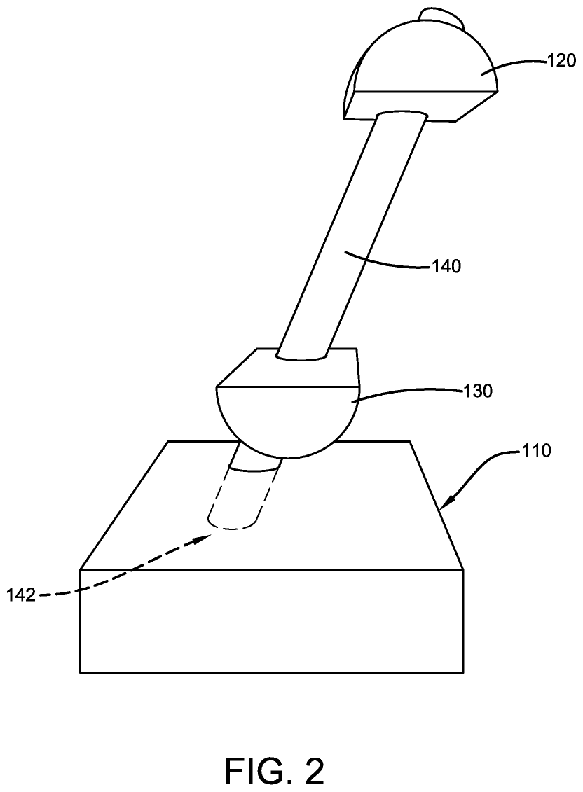

The opening 116 further receives the first end 142 of at least one dowel 140, as best seen in FIG. 2. The first end 142 is preferably angled such that the first end 142 forms an acute angle relative to the bottom surface 114. The angle of the dowel 140 within the angled opening 116 of the base 110 allows the dowel 140 to rest vertically within the base 110. It should be appreciated that the location of the opening 116 in the base 110 is such that the moment force created by the dowel 140 is less than the overturning force of the base 110.

The device 100 is also comprised of a first stand member 120 and a second stand member 130. The first stand member 120 is convex in shape such that it matches the contour of a human wrist. The member 120 is comprised of at least one opening 122 that allows the member 120 to be slid onto the dowel 140 from the second end 144 of the dowel 140.

The member 120 may be made from any material mentioned supra. The member 120 may also be comprised of at least one padding 124. The padding 124 may cover a portion of or the entire member 120. The padding 124 may be any foam, felt, velvet, or other non-scratch material of the like. The padding 124 prevents the member 120 from scratching a watch band 12 while a watch 10 is stored on the device 100 such that the band 12 contacts the member 120.

The second stand member 130 is concave in shape such that it matches the contour of a human wrist. The member 130 is comprised of at least one opening 132 that allows the member 130 to be slid onto the dowel 140 from the second end 144 of the dowel 140.

The member 130 may be made from any material mentioned supra. The member 130 may also be comprised of at least one padding 134. The padding 134 may cover a portion of or the entire member 130. The padding 134 may be any foam, felt, velvet, or other non-scratch material of the like. The padding 134 prevents the member 130 from scratching a watch band 12 while a watch 10 is stored on the device 100 such that the band 12 contacts the member 130.

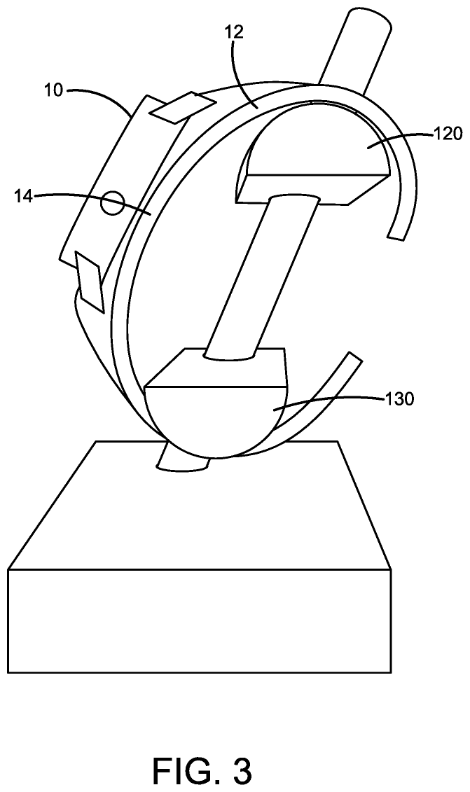

Together, the shape of both members 120, 130 form a generally circular shape to mimic a human wrist. This allows a watch 10 to be easily stored, as seen in FIG. 3. It should be noted that each member 120, 130 does not contact the rear 14 of the watch 10. In this manner, each member 120, 130 cannot scratch or damage the rear 14 of the watch 10 casing.

It should also be noted that the members 120, 130 are perpendicular to the dowel 140 during use and are maintained at said perpendicular position via the moment arm created relative to the dowel 140. The opening 122, 132 of each member 120, 130 may be positioned on any area of the member 120, 130 to create the necessary moment arm.

Because the members 120, 130 attach to the dowel 140 with no fasteners (in an arrangement wherein the members 120, 130 are parallel to the base 110), the members 120, 130 can be repositioned along the dowel 140 to hold watches 10 of different sizes. As such, the device 100 is universal. In one embodiment, the members 120, 130 may be magnetic and can magnetically attach to a metal dowel 140. In addition, the use of no fasteners allows the device 100 to be easily disassembled for transport.

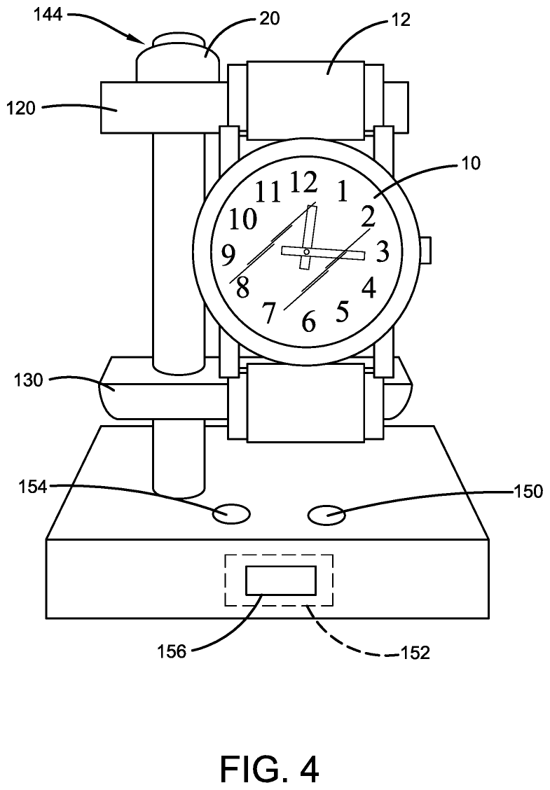

In a further embodiment, the base 110, dowel 140, and members 120, 130 may be magnetic. As a result, jewelry 20 such as rings, bracelets, etc. can magnetically attach to any portion of the device 100 such that the jewelry cannot be easily lost. In this embodiment, all portions of the device 100 may be covered in the padding 124, 134 that was described above. Jewelry 20 may also be hung from the second end 144 of the dowel 140, as seen in FIG. 4.

In one embodiment, the base 110 is comprised of at least one light source 150. The light source 150 is preferably an LED light of any color. The light source 150 is positioned on the base 110 such that it illuminates a watch 10 when the watch 10 is stored on the device 100.

The light source 150 may be automatically activated via at least one sensor 154 that is in electrical communication with the light source 150. The sensor 154 preferably detects light. Once light is detected below a threshold level measured in daylight factor, illuminance, lumens, or any other unit of the like, the light source 150 is automatically activated. As a result, the light source 150 automatically illuminates a watch 10 at night.

The light source 150 is powered by at least one battery 152. The battery 152 may be a disposable battery 152 or a rechargeable battery 152 in the form of an alkaline, nickel-cadmium, nickel-metal hydride battery 152, etc. such as any 3V-12 volts DC battery 152 or other conventional battery 152 such as A, AA, AAA, etc. that supplies power to the device 100. Throughout this specification the terms “battery” and “batteries” may be used interchangeably to refer to one or more wet or dry cells or batteries 152 of cells in which chemical energy is converted into electricity and used as a source of DC power. References to recharging or replacing batteries 152 may refer to recharging or replacing individual cells, individual batteries 152 of cells, or a package of multiple battery cells as is appropriate for any given battery 152 technology that may be used. Additionally, the battery 152 may be recharged by a USB port 156 of any type known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “watch stand device” and “device” are interchangeable and refer to the watch stand device 100 of the present invention.

Notwithstanding the foregoing, the watch stand device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the watch stand device 100 as shown in the FIGS. are for illustrative purposes only, and that many other sizes and shapes of the watch stand device 100 are well within the scope of the present disclosure. Although the dimensions of the watch stand device 100 are important design parameters for user convenience, the watch stand device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A watch stand device comprising:
a base;
a dowel;
a first stand member; and
a second stand member.

2. The watch stand device of claim 1, wherein the first stand member is positioned parallel to the base.

3. The watch stand device of claim 1, wherein the first stand member is comprised of a convex shape.

4. The watch stand device of claim 1, wherein the second stand member is positioned parallel to the base.

5. The watch stand device of claim 1, wherein the first stand member is comprised of a concave shape.

6. The watch stand device of claim 1, wherein the dowel forms an acute angle with a bottom surface of the base.

7. A watch stand device comprising:
a base comprised of a first opening;
a dowel positioned within the first opening;
a first stand member comprised of a second opening; and
a second stand member comprised of a third opening.

8. The watch stand device of claim 7, wherein the dowel forms an acute angle with a bottom surface of the base.

9. The watch stand device of claim 7, wherein the base, the dowel, the first stand member, and the second stand member are each comprised of a magnetic material.

10. A watch stand device comprising:
a base comprised of a first opening;
a dowel positioned within the first opening;
a first stand member comprised of a first padding and a second opening;
a second stand member comprised of a second padding and a third opening;
a light source; and
a battery.

11. The watch stand device of claim 10, wherein the light source is positioned on the base.

12. The watch stand device of claim 10 further comprised of a USB port.

13. The watch stand device of claim 10, wherein the first padding is comprised of a foam, a felt, or a velvet material.

14. The watch stand device of claim 10, wherein the second padding is comprised of a foam, a felt, or a velvet material.

15. The watch stand device of claim 10, wherein the base is comprised of a magnetic base.

16. The watch stand device of claim 10 further comprised of a sensor.

17. The watch stand device of claim 16, wherein the sensor is in electrical communication with the light source.

18. The watch stand device of claim 10, wherein the dowel forms an acute angle with a bottom surface of the base.

19. The watch stand device of claim 10, wherein a bottom surface of the base is comprised of a non-slip material.

20. The watch stand device of claim 19, wherein the non-slip material is comprised of a texture.
